(19) United States
(12) Patent Application Publication
(10) Pub. No.: US 2007/0140578 A1
(43) Pub. Date: Jun. 21, 2007

(54) Image adjustment apparatus, image adjustment method and computer readable medium

(75) Inventor: Masaru Okutsu, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/453,058

(22) Filed: Jun. 15, 2006

(30) Foreign Application Priority Data
Dec. 16, 2005 (JP) 2005-362674

(51) Int. Cl. G06K 9/40; G06K 9/00

(52) U.S. Cl. 382/254; 382/162

(57) ABSTRACT

An image adjustment apparatus includes: a feature information acquisition part that acquires feature information concerning a target image to be adjusted with respect to an adjustment item; an item decision part that selects an item as the adjustment item from among a plurality of predetermined adjustment item candidates based on the acquired feature information; and an adjustment amount acquisition part that presents the selected adjustment item and acquires an adjustment amount with respect to the presented adjustment item based on an input by a user, the target image being to be adjusted based on the acquired adjustment amount.

### COROSS-REFERENCE TO RELATED APPLICATION

This application claims priority under 35 USC 119 from Japanese Patent Application No. 2005-362674 filed on Dec. 16, 2005, the disclosure of which is incorporated by reference therein.

### BACKGROUND

1. Technical Field

The present invention relates to an image adjustment apparatus, an image adjustment method and a program for adjusting image quality of an image.

2. Related Art

There is an image adjustment apparatus for making image quality adjustments such as a sharpness adjustment or a color balance adjustment to an image such as a photographic image, for example, before outputting to a medium such as paper. Such an image adjustment apparatus normally performs image adjustment processing for adjusting an image based on detailed instructions of a user.

### SUMMARY

According to an aspect of the invention, there is provided an image adjustment apparatus including: a feature information acquisition part that acquires feature information concerning a target image to be adjusted with respect to an adjustment item; an item decision part that selects an item as the adjustment item from among a plurality of predetermined adjustment item candidates based on the acquired feature information; and an adjustment amount acquisition part that presents the selected adjustment item and acquires an adjustment amount with respect to the presented adjustment item based on an input by a user, the target image being to be adjusted based on the acquired adjustment amount.

### BRIEF DESCRIPTION OF THE DRAWINGS

Embodiment of the present invention will be described in detail based on the following figures, wherein:

FIG. 1 is a block diagram showing an exemplary schematic configuration of an image adjustment apparatus according to an embodiment of the invention;

FIG. 2 is a functional block diagram showing an example of a function of the image adjustment apparatus;

FIG. 3 is a diagram showing an example of adjustment item candidates retained by the image adjustment apparatus;

FIG. 4 is a flow diagram showing an example of processing performed by the image adjustment apparatus;

FIG. 5 is a diagram showing an example of a target image to be processed by the image adjustment apparatus;

FIG. 6 is a diagram showing an example of a screen that a display part displays by a presentation processing of an adjustment item;

FIG. 7 is a diagram showing another example of the screen that the display part displays by the presentation processing of the adjustment item; and

FIG. 8 is a diagram showing another example of the screen that the display part displays by the presentation processing of the adjustment item.

### DETAILED DESCRIPTION

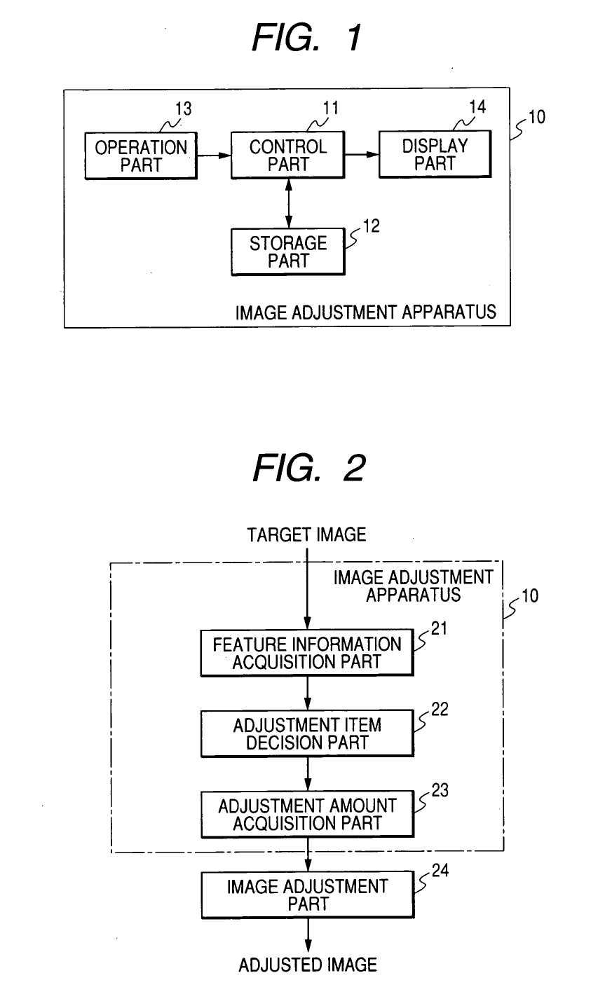

An embodiment of the invention will be described below with reference to the drawings. An image adjustment apparatus 10 according to an embodiment of the invention is configured to include a control part 11, a storage part 12, an operation part 13 and a display part 14 as shown in FIG. 1.

Here, the control part 11 is a CPU etc. and operates following to a program stored in the storage part 12. Particularly in the present embodiment, the control part 11 decides adjustment items based on feature information about a target image and performs processing for acquiring an adjustment amount necessary for an image adjustment to each of the adjustment items. The contents of processing performed by the control part 11 will be described below in detail.

The storage part 12 is configured to include at least one of a disk device etc. and a memory element such as RAM or ROM. Data of the target image to be processed in the embodiment or a program performed by the control part 11 is stored in this storage part 12. Also, the storage part 12 operates as work memory of the control part 11.

The operation part 13 is, for example, a keyboard, a mouse or an operation button, and accepts an instruction operation of a user and outputs the contents of the instruction operation to the control part 11. The display part 14 is, for example, a display, and displays information according to instructions from the control part 11.

The image adjustment apparatus 10 is configured to functionally include a feature information acquisition part 21, an adjustment item decision part 22 and an adjustment amount acquisition part 23 as shown in FIG. 2. For example, the control part 11 executes programs stored in the storage part 12 and thereby these functions can be implemented. Also, the image adjustment apparatus 10 may be configured to functionally include an image adjustment part 24.

The feature information acquisition part 21 first acquires data of a target image to be processed. The target image may be previously stored in the storage part 12 or may be acquired by reading out image data stored in a computer-readable storage medium by a reader (not shown). Or, the target image may be acquired from another device such as a cellular telephone, a digital camera or a scanner connected to the image adjustment apparatus 10.

Then, the feature information acquisition part 21 acquires predetermined feature information about a target image. The feature information acquisition part 21 can acquire the feature information by calculating a feature amount based on color component values (for example, values indicating lightness of respective component colors of red, green, blue) of each of the pixels included in the target image by making an image analysis of, for example, the target image. A concrete example of such a feature amount includes an average value of saturation or an average value of lightness of each of the pixels, etc. Also, the feature information acquisition part 21 may calculate an average value of luminance differences (edge amount) between each of the pixels adjacent in the target image as a feature amount. Here, the lightness, saturation or luminance of each of the pixels can be calculated by being computed by a predetermined computation formula based on a color component value of each of the pixels or converting a color component value of each of the pixels into a color component value in predetermined color space.

Also, the feature information acquisition part 21 may acquire the maximum value (maximum lightness value) among color component values of each of the pixels included in a target image with respect to each of, for example, red (R), green (G), blue (B) as a feature amount. Or, a difference value (luminance range) between the maximum value and the minimum value among luminances of each of the pixels included in the target image may be calculated as a feature amount.

Also, the feature information acquisition part 21 determines whether or not a color component value of each of the pixels included in a target image satisfies a predetermined condition, and a ratio between pixels satisfying the predetermined condition and the whole target image may be calculated as a feature amount. Concretely, for example, determination whether or not a value representing a hue is included within a predetermined range in the case of converting a color component value of each of the pixels into a color component value in LCH color space is used as the predetermined condition. As a result of this, the feature information acquisition part 21 can acquire a ratio at which a pixel of a hue of flesh color (flesh pixel), a pixel of a hue of green color (green pixel), a pixel of a hue of sky blue color (sky blue pixel), etc. are included in the target image as feature information.

Further, the feature information acquisition part 21 may acquire information (photography information) about a photography condition of a target image as feature information when the target image is a photographic image. The photography information is, for example, information associated with the target image and recorded by an imaging device such as a digital camera used in photography of the photographic image, and is information about brightness of the periphery at the time of photography, scene information (for example, a standard, a night scene, a landscape or a person) specified for an imaging device by a user at the time of photography, focus information indicating which mode of automatic focus or manual focus a photograph is taken, etc. The feature information acquisition part 21 can acquire photography information retained in a state of being associated with the target image while acquiring image data of the target image.

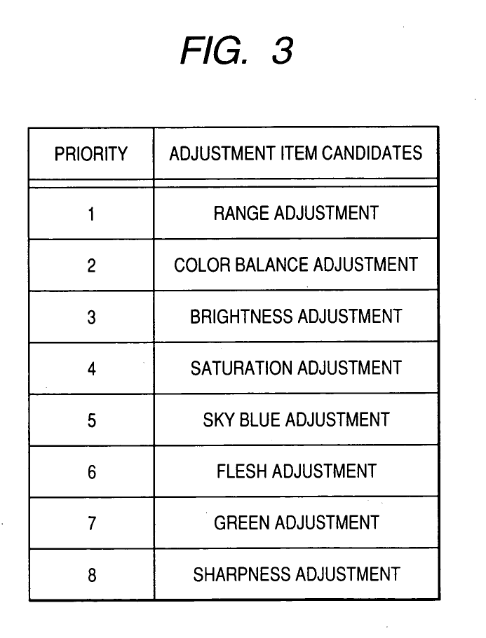

The adjustment item decision part 22 decides an adjustment item indicating processing to be adjusted to a target image base don feature information acquired by the feature information acquisition part 21. The adjustment item decision part 22 can decide an adjustment item by making a selection from among, for example, predetermined adjustment item candidates. The adjustment item candidates are items indicating the contents of adjustment processing and are previously retained in the storage part 12. As one example, a list of adjustment item candidates as shown in FIG. 3 is retained in the storage part 12.

An example of processing in which the adjustment item decision part 22 decides whether or not each of the adjustment item candidates is included in an adjustment item to a target image based on feature information will be described below.

For example, the adjustment item decision part 22 decides an adjustment item based on a decision as to whether or not each of the average value of lightness, the average value of saturation and the average value of the edge amount is within a range decided by a predetermined threshold value. For example, when the average value of lightness is a predetermined threshold value TL1 or less, there is a possibility that a target image is a dark image as a whole and is in an underexposure state. Also, when the average value of lightness is a predetermined threshold value TL2 (>TL1) or more, there is a possibility that a target image is a bright image as a whole and is in an overexposure state. However, in both the cases, a photographic subject is originally bright or dark and it may be unnecessary to adjust an image. Thus, the image adjustment apparatus 10 performs image adjustment processing for adjusting brightness using an adjustment amount acquired based on an input of a user later by deciding a brightness adjustment included in adjustment item candidates as an adjustment item without automatically performing image adjustment processing.

In the same way, when the average value of saturation is a predetermined threshold value TC1 or less or the average value of saturation is a predetermined threshold value TC2 (>TC1) or more, the adjustment item decision part 22 decides a saturation adjustment as an adjustment item. Also, when the average value of the edge amount is a predetermined threshold value TE1 or less or the average value of the edge amount is a predetermined threshold value TE2 (>TE1) or more, a sharpness adjustment is decided as an adjustment item.

Also, the adjustment item decision part 22 may decide whether or not a color balance adjustment is included in an adjustment item based on the maximum lightness values of each of the component colors. For example, a value of difference between the maximum value and the minimum value among the maximum lightness values of each of the component colors is calculated. When it is assumed that the component colors is R, G, B and respective maximum lightness values are represented by Mr, Mg, Mb, a difference value Z can be calculated by Max(Mr, Mg, Mb) −Min (Mr, Mg, Mb). Here, Max(a, b, c) represents the largest value of a, b, c, and Min(a, b, c) represents the smallest value of a, b, c. Then, when the difference value Z is larger than a predetermined threshold value TZ1 and is smaller than a predetermined threshold value TZ2 (>TZ1), it is determined that a certain deviation occurs in color balance, and the color balance adjustment is decided as the adjustment item. On the other hand, when Z≦TZ1, it is determined that a deviation of color balance does not occur, and it is decided that the color balance adjustment is not included in the adjustment item. Also, when Z≧TZ2, a large deviation occurs in color balance, and it is difficult to adjust the color balance, so that it is also decided that the color balance adjustment is not included in the adjustment item.

Also, the adjustment item decision part 22 may decide whether or not a range adjustment is included in an adjustment item based on a luminance range. For example, when the luminance range is a predetermined threshold value TR or less, luminance distribution of a target image is distributed in a narrower range than a range of luminance capable of representation, so that the range adjustment is decided as the adjustment item.

Also, the adjustment item decision part 22 may decide whether or not a flesh adjustment, a green adjustment, a sky blue adjustment, etc. are included in an adjustment item based on a ratio between a pixel (such as a flesh pixel, a green pixel or a sky blue pixel) having a hue of a particular range and the whole target image. For example, when a ratio of the flesh pixel to the whole target image exceeds a predetermined threshold value, it is decided that the flesh adjustment is to be made. In same way, when a ratio of the green pixel exceeds a predetermined threshold value, it is decided that the green adjustment is to be made, and when a ratio of the sky blue pixel exceeds a predetermined threshold value, it is decided that the sky blue adjustment is to be made.

Also, the adjustment item decision part 22 may decide an adjustment item based on photography information such as scene information acquired by the feature information acquisition part 21. For example, when the scene information has a particular value, decision may be made so as to always include a predetermined adjustment item or decision maybe made so as not to include a predetermined adjustment item. As a concrete example, when the scene information is a “night scene”, a range adjustment, a color balance adjustment, a brightness adjustment and a saturation adjustment are decided as adjustment items. Also, when the scene information is a “person”, decision is made so as to include a flesh adjustment and a sharpness adjustment in adjustment items in addition to the adjustment items of the case of the “night scene”. Further, when the scene information is a “landscape”, decision is made so as to include a sky blue adjustment, a green adjustment and a sharpness adjustment in adjustment items in addition to the adjustment items of the case of the “night scene”. Also, when the scene information is “normal”, for example, all the adjustment item candidates may be decided as adjustment items or when the scene information is “normal”, an adjustment item maybe decided using a feature amount calculated based on the color component value of each of the pixels described above. Also, the adjustment item decision part 22 may decide an adjustment item candidate such as a brightness adjustment as an adjustment item using, for example, information about brightness of the periphery at the time of photography.

Incidentally, the examples described above are illustrative, and a method in which the adjustment item decision part 22 decides an adjustment item based on feature information is not limited to these examples. Also, these methods may be combined properly to decide an adjustment item.

Further, the adjustment item decision part 22 may decide presentation order of adjustment items based on feature information acquired by the feature information acquisition part 21. It is assumed that information about priority is associated with adjustment item candidates and is stored in the storage part 12 as shown in, for example, a list of adjustment item candidates illustrated in FIG. 3. In this case, the adjustment item decision part 22 decide presentation order of adjustment items based on the information about priority associated with the adjustment item candidates. As a result of this, a user inexperienced in image quality adjustment of an image can also be prompted to input an adjustment amount to an adjustment item in desirable order.

Also, the adjustment item decision part 22 may present an adjustment item to a user based on feature information acquired by the feature information acquisition part 21 and determine whether an adjustment amount to the adjustment item is acquired based on an input of the user or automatic image adjustment processing for adjusting an image automatically according to a feature amount etc. of a target image is performed.

When focus information included in photography information is “automatic focus” as a concrete example, it can be guessed that a user is not concerned with an adjustment of image quality and the image adjustment at the time of photography is left to an imaging device. In such a case, with respect to an image quality adjustment of a target image at the time of output, it maybe decided that a user does not make an adjustment by inputting an adjustment amount with respect to an adjustment item on user's own and the image adjustment apparatus 10 should automatically make an adjustment according to a feature amount etc. of a target image, and it may be determined that the adjustment item decision part 22 performs image adjustment processing to an adjustment item necessary to make an adjustment without input of the user.

The adjustment amount acquisition part 23 performs presentation processing for presenting an adjustment item decided by the adjustment item decision part 22 by displaying the adjustment item on, for example, the display part 14. In this presentation processing, a user interface such as an adjustment bar or a predetermined button for accepting an input from a user may be displayed on the display part 14. Further, the adjustment amount acquisition part 23 acquires an adjustment amount with respect to each of the presented adjustment items based on information that a user inputs by an instruction operation to the operation part 13. Here, the adjustment amount acquisition part 23 may present an adjustment item one by one sequentially based on presentation order decided by the adjustment item decision part 22 rather than presenting all the adjustment items at once and present the next adjustment item after acquiring an adjustment amount with respect to the presented adjustment item.

The image adjustment part 24 performs image adjustment processing for adjusting image quality of a target image based on the adjustment amount acquired by the adjustment amount acquisition part 23. Incidentally, the image adjustment part 24 may be implemented by execution of a predetermined program by the control part 11 of the image adjustment apparatus 10 or may be implemented by execution of a predetermined program by an external device connected to the image adjustment apparatus 10 such as a printer or a personal computer. In this case, the image adjustment apparatus 10 outputs the adjustment amount acquired by the adjustment amount acquisition part 23 to the external device. Then, the external device performs image adjustment processing using the adjustment amount outputted from the image adjustment apparatus 10. An adjusted image obtained as a result of performing the image adjustment processing with respect to a target image is, for example, stored in the storage part 12 or is outputted by an image formation device such as a printer. As a result of this, a user can obtain the adjusted image in which the image adjustment processing is performed.

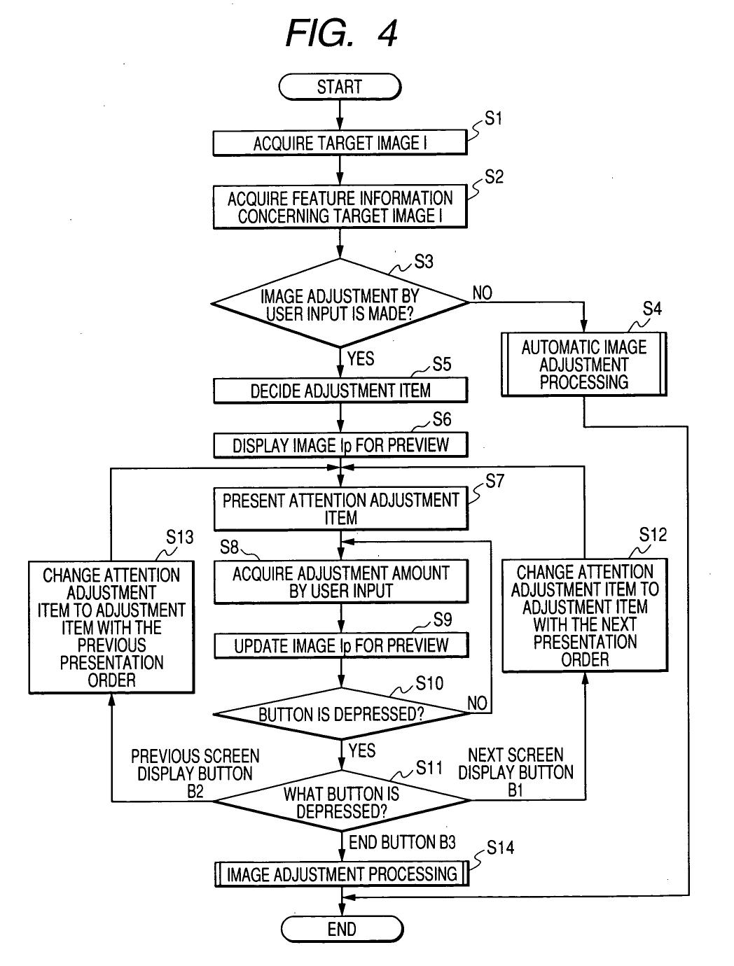

Next, an example of processing performed by the image adjustment apparatus 10 will be described based on a flow diagram of FIG. 4.

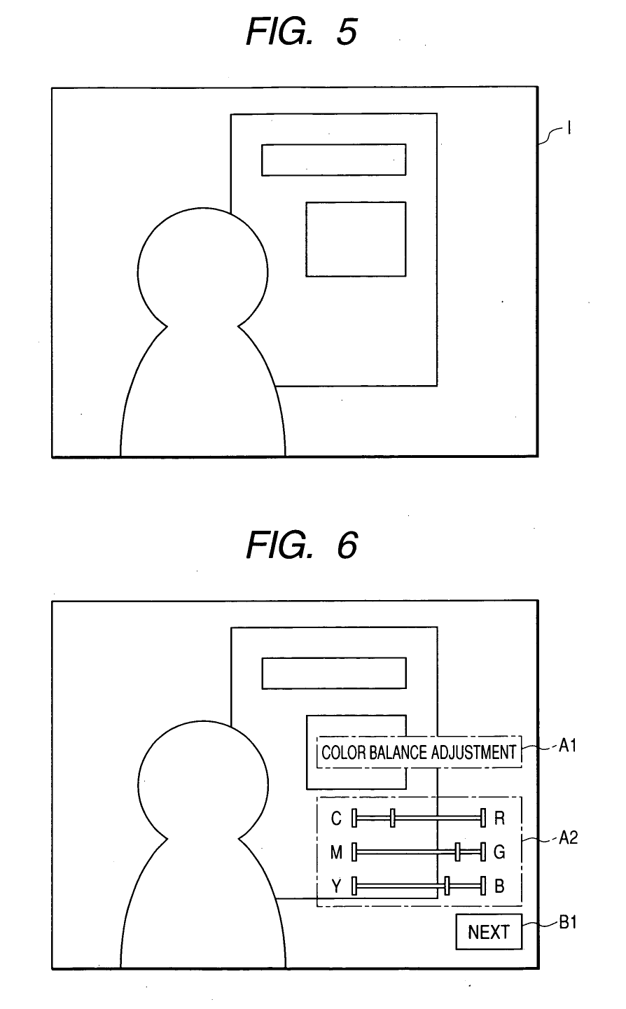

First, the feature information acquisition part 21 acquires a target image I to be processed based on an instruction operation etc. of a user (S1). As an example herein, the target image I shall be a photographic image including some person as illustrated in FIG. 5. Subsequently, the feature information acquisition part 21 acquires predetermined feature information about the target image I (S2).

Next, the adjustment item decision part 22 determines whether or not an image adjustment by a user input is to be made based on the feature information obtained by processing of S2 (S3). When the adjustment item decision part 22 determines that an image quality adjustment by the user input is not to be made, for example, in the case where focus information is “automatic focus”, the image adjustment apparatus 10 performs automatic image adjustment processing based on a predetermined adjustment amount decided based on the feature information (S4).

On the other hand, in the case of determining that the image quality adjustment by the user input is made, the adjustment item decision part 22 decides presentation order of adjustment items and the adjustment items with respect to the target image I from among adjustment item candidates (S5). As a concrete example herein, the decided adjustment items are a color balance adjustment, a flesh adjustment and a sharpness adjustment, and presentation order shall be this order.

Then, the adjustment amount acquisition part 23 generates an image Ip for preview based on the target image I and displays the image Ip for preview on the display part 14 (S6). Here, the image Ip for preview is an image smaller than the target image I obtained by image processing etc. for scaling down the target image I. The adjustment amount acquisition part 23 decides a size of the generated image Ip for preview based on, for example, a size of a display area of the display part 14.

Subsequently, the adjustment amount acquisition part 23 performs presentation processing for presenting an attention adjustment item (S7). Here, the attention adjustment item is an adjustment item under a presentation processing at a time when the adjustment amount acquisition part 23 performs the processing of S7, and an adjustment item with the first presentation order shall be set as the attention adjustment item in the case of first performing the processing of S7.

When a color balance adjustment which is an adjustment item with the first presentation order is set as an attention adjustment item as a concrete example, the adjustment amount acquisition part 23 performs presentation processing of the attention adjustment item by displaying a screen as illustrated in FIG. 6 on the display part 14. In the example of FIG. 6, the adjustment item decision part 22 displays the image Ip for preview on the display part 14, and displays an item name of an attention adjustment item of “color balance adjustment” in an adjustment item name display area Al arranged on a screen of the display part 14 so as to overlap with the image Ip for preview. Also similarly, adjustment bars for making a user input an adjustment amount with respect to an adjustment item of the color balance adjustment are displayed in an adjustment bar display area A2 arranged so as to overlap with the image Ip for preview. Also, a next screen display button B1 in which a user performs an instruction operation for presenting the next adjustment item is displayed.

Thus, the adjustment item name display area A1, the adjustment bar display area A2, the next screen display button B1, etc. are arranged so as to overlap with the image Ip for preview and are displayed on the display part 14 and thereby, for example, even when a display area of the display part 14 is small, the adjustment amount acquisition part 23 can present the necessary information to a user.

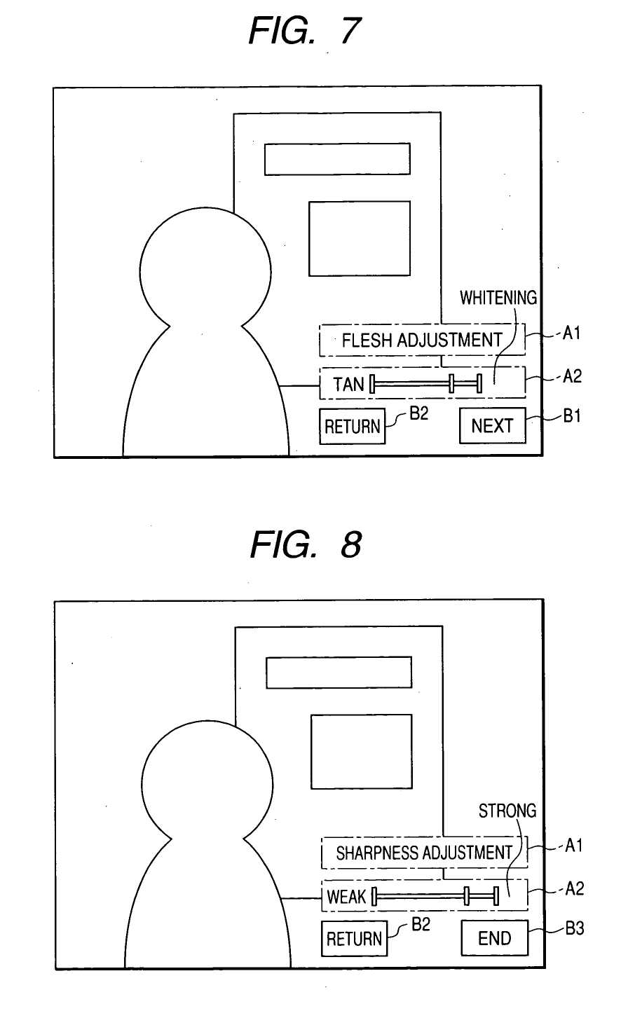

Also, when an adjustment item with an intermediate presentation order except the first and last presentation orders is set as an attention adjustment item, the adjustment amount acquisition part 23 displays a screen as illustrated in FIG. 7 on the display part 14. FIG. 7 is an example of the case of setting a flesh adjustment as an attention adjustment item, and the adjustment amount acquisition part 23 displays a previous screen display button B2 in which a user performs an instruction operation for presenting the previous adjustment item in addition to the next screen display button B1 described above. Also, the adjustment amount acquisition part 23 changes a size or a position with respect to the image Ip for preview of the display area A2 for adjustment amount input or the adjustment item name display area A1 according to an adjustment item and then displays the size or the position on the display part 14.

Further, when an adjustment item with the last presentation order is set as an attention adjustment item, the adjustment amount acquisition part 23 displays a screen as illustrated in FIG. 8 on the display part 14. FIG. 8 is an example of the case of setting a sharpness adjustment as an attention adjustment item, and the adjustment amount acquisition part 23 displays the previous screen display button B2 described above and also an end button B3 instead of the next screen display button B1 on the display part 14.

When the adjustment amount acquisition part 23 performs presentation processing of the attention adjustment item, a user performs an adjustment amount input operation for inputting an adjustment amount with respect to the attention adjustment item by performing an instruction operation from the operation part 13 to the adjustment bar displayed in the adjustment bar display area A2 of the display part 14. As a result of this, the adjustment amount acquisition part 23 acquires the adjustment amount with respect to the attention adjustment item (S8).

Here, the adjustment item decision part 22 performs image adjustment processing with respect to the image Ip for preview according to the adjustment amount inputted by the processing of S8 and based on its result, the image Ip for preview displayed on the display part 14 is updated (S9). As a result of this, a user can perform an instruction operation with respect to the adjustment bar while checking a result of the image adjustment and can input an adjustment amount capable of making the image adjustment as the user wishes. Also, by using the image Ip for preview which is an image smaller than the target image I herein, the adjustment item decision part 22 can display an image of the adjusted result on the display part 14 by simpler processing as compared with the case of performing image adjustment processing with respect to the target image I itself.

In this state, the adjustment amount acquisition part 23 monitors whether or not a user performs an instruction operation for depressing each of the buttons displayed on the display part 14 with respect to the operation part 13 (S10) Then, by repeating the processing of S8 and S9 until the button is depressed, a user can perform an adjustment amount input operation.

When the instruction operation of button depression is performed by a user, the adjustment amount acquisition part 23 performs each of the following processing by a kind of the depressed button (S11). That is, when the next screen display button B1 is depressed, the adjustment amount acquisition part 23 changes an attention adjustment item to an adjustment item with the next presentation order with respect to the attention adjustment item at a time of depressing the button (S12). When the attention adjustment item at a time of depressing the button is a color balance adjustment in the case of the example described above, a flesh adjustment is set as a new attention adjustment item. Then, presentation processing of the new attention adjustment item is performed after returning to the processing of S7. As a result of this, a user can input an adjustment amount in order one by one based on the presentation order decided by the adjustment item decision part 22, and can adjust an image in desirable order even when the order to make an adjustment is not known.

Also, when the depressed button is the previous screen display button B2, the adjustment amount acquisition part 23 changes an attention adjustment item to an adjustment item with the previous presentation order with respect to the attention adjustment item at a point in time of depressing the button (S13). When the attention adjustment item at a time of depressing the button is a flesh adjustment in the case of the example described above, a color balance adjustment is set as a new attention adjustment item. Then, presentation processing of the new attention adjustment item is performed after returning to the processing of S7. As a result of this, a user can again present the adjustment item in which an input of an adjustment amount is previously ended to the image adjustment apparatus 10 and can again do an input of the adjustment amount.

Also, when the depressed button is the end button B3, the adjustment amount acquisition part 23 ends processing for acquiring the adjustment amount based on input of the user. Then, based on the adjustment amounts acquired by the adjustment amount acquisition part 23 until now, the image adjustment part 24 performs image adjustment processing with respect to the target image I and outputs a result (S14).

The foregoing description of the embodiments of the present invention has been provided for the purpose of illustration and description. It is not intended to be exhaustive or limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image adjustment apparatus comprising:
a feature information acquisition part that acquires feature information concerning a target image to be adjusted with respect to an adjustment item;
an item decision part that selects an item as the adjustment item from among a plurality of predetermined adjustment item candidates based on the acquired feature information; and
an adjustment amount acquisition part that presents the selected adjustment item and acquires an adjustment amount with respect to the presented adjustment item based on an input by a user, the target image being to be adjusted based on the acquired adjustment amount.

2. The image adjustment apparatus according to claim 1,
wherein the adjustment item includes a plurality of adjustment items, and
wherein the adjustment amount acquisition part acquires the adjustment amount for each of the presented adjustment items.

3. The image adjustment apparatus according to claim 2,
wherein the adjustment item decision part decides a presentation order of presenting the adjustment items that the target image is decided to be adjusted with respect to, and
wherein the adjustment amount acquisition part presents the adjustment items sequentially based on the decided presentation order.

4. The image adjustment apparatus according to claim 1, wherein the feature information acquisition part acquires as the feature information at least one of an average value of lightness in the target image, an average value of saturation in the target image, an average value of luminance differences between adjacent pixels in the target image, a difference value between a maximum value and a minimum value of luminance in the target image and a maximum lightness value of each component color of the target image.

5. The image adjustment apparatus according to claim 1, wherein the feature information acquisition part acquires as the feature information a ratio between a pixel that has a color component value satisfying a predetermined condition and the whole pixels included in the target image.

6. The image adjustment apparatus according to claim 1, wherein the feature information acquisition part acquires as the feature information photography information indicating a photographing condition of the target image when the target image is a photographic image.

7. An image adjustment method comprising:
acquiring feature information concerning a target image to be adjusted with respect to a adjustment item,
selecting an item as the adjustment item from among a plurality of predetermined adjustment item candidates based on the acquired feature information,
presenting the selected adjustment item; and
acquiring an adjustment amount with respect to the presented adjustment items based on an input by a user, the target image being to be adjusted based on the acquired adjustment amount.

8. A computer readable medium storing a program causing a computer to execute a process for adjusting an image, the process comprising:
acquiring feature information concerning a target image to be adjusted with respect to an adjustment item,
selecting an item as the adjustment item from among a plurality of predetermined adjustment item candidates based on the acquired feature information,
presenting the selected adjustment item; and
acquiring an adjustment amount with respect to the presented adjustment items based on an input by a user, the target image being to be adjusted based on the acquired adjustment amount.
